(19) United States
(12) Patent Application Publication
(10) Pub. No.: US 2007/0260906 A1
(43) Pub. Date: Nov. 8, 2007

(54) Clock synchronization method and apparatus

(76) Inventor: Paul L. Corredoura, Redwood City, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/429,748

(22) Filed: May 8, 2006

(51) Int. Cl. G06F 1/12

(52) U.S. Cl. 713/400

(57) ABSTRACT

A clock synchronization apparatus; a network having master and slave clocks; and a method of synchronizing clocks are disclosed.

### BACKGROUND

Many electronic devices and systems require multiple clocking devices for operation. For example, in many automated systems, it is necessary to provide clocks in multiple locations for the proper function of various components of the systems. Often, the synchronization of these clocks is essential to accuracy and performance.

One method of providing clock synchronization is described according to IEEE Standard 1588, often referred to as the IEEE Standard Precision Time Protocol (PTP). Under this protocol, a master clock communicates with one or more slave clocks via a network link such as an Ethernet link. Periodically, the master clock transmits its time to the slave clocks, which adjust their clock values to the master clock time including accounting for propagation delay values between the master clock and the respective slave clocks.

Currently, the IEEE 1588 protocol and other known synchronization standards rely on frequency locking of the master and slave clocks. In particular, the master and slave clock signals are digital signals that provide a clock function via counters. If the counters of the master clock and a slave clock have the same value, the clocks are deemed synchronized and no adjustment is made. If the counters of the slave clock and master clock differ by one count, an adjustment is made at the slave counter to return the clocks to synchronization. Thus, it is not until the master and slave clocks differ by one count in time is any adjustment made. This is often referred to as the limit cycle.

While frequency locking is useful in clock synchronization of master and slave clocks, the limit cycle provides intrinsic inaccuracy due to phase offset between the clocks. For example, if a master and a slave clock operate at the same frequency, but were out of phase by 180 degrees, they would have the same count value (i.e., be synchronized) for one-half clock period of each clock cycle and differ by one count value (i.e., not be synchronized) for one-half clock period of each clock cycle. Furthermore, because the relay of the master clock time between the master clock and slave clocks occurs relatively infrequently (on the order of 1.0 Hz), a significant number of clock cycles can pass in high-speed applications (e.g., 10 MHz) with the clocks out of synchronization. In many applications, such errors in synchronization are unacceptable.

There is a need, therefore, for a method and apparatus for synchronizing clocks that overcomes at least the shortcomings of known clock synchronization architectures.

### SUMMARY

In accordance with an illustrative embodiment an apparatus includes a master clock counter; a servo controller; and a slave clock counter. The apparatus also includes an error detector block operative to determine a time difference between the slave clock counter and the master clock counter including a relative phase of the master and slave clock counters. In addition, the apparatus includes an accumulator, which receives a delta delay value from the servo controller based on a present time difference and previous time differences. The accumulator is adapted to output an increment value and a fractional value. Furthermore, the apparatus includes a variable delay block, which receives the increment value and the fractional value, and is operative to adjust the slave clock counter based on the increment value and the fractional value.

In accordance with another illustrative embodiment, a network includes a plurality of nodes, wherein one of the plurality nodes comprises a master clock counter and each of the other nodes comprises a slave clock counter. The network also includes a clock synchronization device, which includes an error detector block operative to determine a time difference between the slave clock counter and the master clock counter including a relative phase of the master and slave clock counters. In addition, the clock synchronization device includes an accumulator, which receives a delta delay value from the servo controller based on a present time difference and previous time differences. The accumulator is adapted to output an increment value and a fractional value. Furthermore, the clock synchronization device includes a variable delay block, which receives the increment value and the fractional value, and is operative to adjust the slave clock counter based on the increment value and the fractional value.

In accordance with yet another illustrative embodiment, a method of synchronizing clocks includes: determining a count difference and a fractional delay between a master clock and a slave clock; and adjusting a clock edge that clocks a slave clock counter by an amount equal to the fractional delay to synchronize the master clock with the slave clock.

### BRIEF DESCRIPTION OF THE DRAWINGS

The illustrative embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 is a conceptual diagram of a network including master and slave clocks in accordance with an illustrative embodiment.

FIG. 2 is a simplified block diagram of a master-slave clock synchronization apparatus in accordance with an illustrative embodiment.

FIGS. 3A and 3B are timing diagrams showing a master clock time a slave clock time and needed correction for synchronization in accordance with an illustrative embodiment.

FIG. 4 is a simplified block diagram of a master-slave clock synchronization apparatus in accordance with an illustrative embodiment.

FIG. 5 is a simplified schematic diagram of a variable delay element in accordance with an illustrative embodiment.

FIG. 6 is a simplified schematic diagram of a variable delay element in accordance with an illustrative embodiment.

FIG. 7 is a flow-chart of a method of synchronizing clocks in accordance with an illustrative embodiment.

### DETAILED DESCRIPTION

In the following detailed description, for purposes of explanation and not limitation, specific details are set forth in order to provide a thorough understanding of illustrative embodiments according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparati and methods may be omitted so as to not obscure the description of the illustrative embodiments. Such methods and apparati are clearly within the scope of the present teachings.

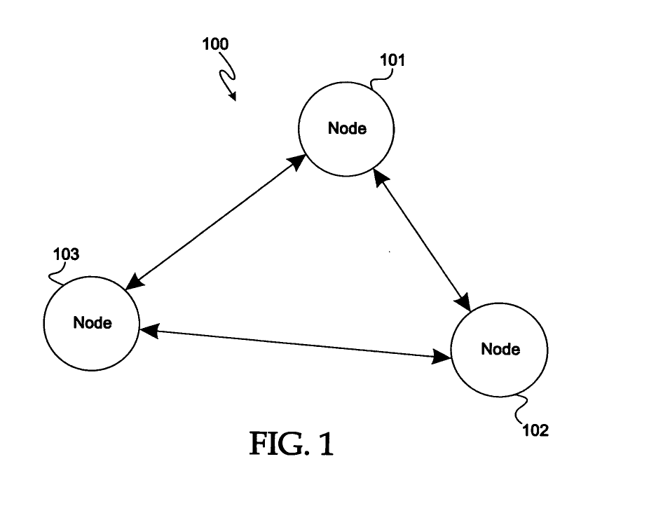

FIG. 1 is a conceptual diagram of a network 100 in accordance with an illustrative embodiment. In an embodiment, the network 100 is a local area network (LAN) and includes a plurality of nodes 101-103. The nodes may be components of a measurement system or a control system, or both. The network 100 may be of the type contemplated by IEEE 1588. The network 100 may function under known protocols such as the Ethernet protocol (IEEE 802.3). Furthermore, the network 100 may be a wireless network operating under a wireless protocol such as IEEE 802.11 or 802.15. In addition, the network 100 may be a centralized wireless network or a decentralized wireless network. It is emphasized that the referenced protocols and networks are merely illustrative and that other protocols are contemplated.

Regardless of the type of network deployed, the clocks of the nodes 101-103 require synchronization. In accordance with illustrative embodiments described herein, clock synchronization is between a master clock and slave clocks. The master clock may be resident in one of the nodes (e.g., node 101) and a slave clock resident in each of the other nodes (e.g., nodes 102, 103).

During normal operation, and in accordance with the selected protocol of the network 100, the node of the master clock occasionally transmits a master time for reception by the slave clocks. This transmission may be part of a beacon transmission by the node, or may be provided in routine communications from the node with the master clock to the other nodes of the network. Regardless, the nodes receive the master clock time and also measure the relative phase between a known predefined feature on the arriving master time message and the rising (or falling) edge of a local clock oscillator. Along with the previously estimated path length delay, this information is used to synchronize the slave time to the master clock time to within an error measurement threshold. Path length delay correction is described in the IEEE 1588 Standard.

By adding the additional phase information to the master clock time information the local servo loop becomes a true phase locked loop instead of a simple frequency locked loop. As described more fully herein, this error measurement threshold is the smallest fraction of a clock period (phase) the local system is capable of measuring. This provides a significant improvement in accuracy compared to known frequency locked loop systems, which provide accuracy to only ±1 clock period or count.

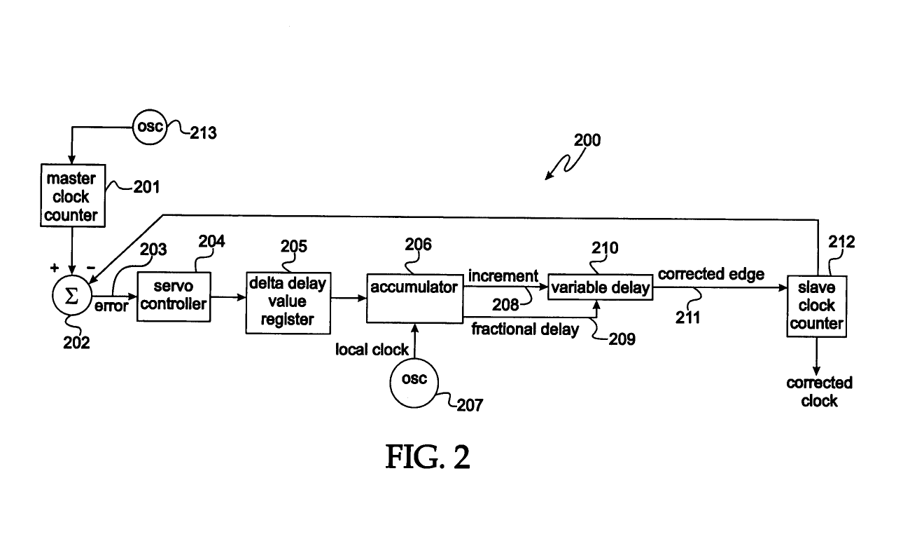

FIG. 2 is a simplified block diagram of an apparatus 200 adapted to synchronize a master clock to a slave clock in accordance with an illustrative embodiment. The apparatus 200 may be resident in one of the nodes 101-103 of the network 100, excepting a master clock counter 201, which is resident at the node with the master clock, and is driven by a master oscillator 213. The apparatus 200 is described as a series of functional blocks that can be implemented in either dedicated hardware or software running on a microprocessor. With exception to the incoming time message phase detector and a variable delay element (to be described in detail below), the apparatus 200 comprises known digital-signal-processing (DSP) elements such as counters, adders and multipliers.

The master clock counter 201 provides a master clock count (or master time) to an error detector block 202 in a remote node via a network message at predefined intervals. The error detector block 202 also receives the slave clock count from a slave clock counter 212 and computes the difference between the master clock time and the local (or slave) clock time. This difference represents the integer portion of the slave time error.

In addition to the integer error, the error detector block 202 also measures the relative phase between an edge of the local clock (rising or falling) and a predefined feature in the incoming master time message (e.g., a rising or falling edge of one or more of the data transitions). The error detector block 202 then adds this fractional portion of the error to the integer portion described earlier. Fractional time error is defined as time errors less than one master clock period. Beneficially, the present teachings provide for the measurement of fractional time error, which is not provided by the IEEE 1588 time protocol standard.

The integer and fractional error values 203 are sent to a servo controller 204. The servo controller 204 uses the incoming integer and fractional error information to adjust the contents of a delta delay value register 205. Using servo controller design techniques familiar to one of ordinary skill in control systems, many variations of the servo controller 204 can be implemented. Regardless of the servo controller design, it is useful for the servo controller 204 to retain the previous delta delay value if the incoming error is zero. Notably, the servo controller 204 must contain an integral term. A proportional-integral (PI) controller or a proportional-integral-derivative (PID) controller are common controllers which would satisfy the requirements.

Beneficially, the delta delay value register 205 is adapted to represent the delta delay with sufficient precision to not add significant errors due to digital word truncation. Once the servo loop has locked, the delta delay value reflects the frequency error of the local oscillator 207 compared to that of the master oscillator 213. For example, if the master oscillator has a period of 100 ns while the local slave oscillator has a period of 99 ns (slave running fast), the delta delay value will converge to a value of 99/100 of the master clock period (100 ns) or 99 ns.

The accumulator block 206 adds the value contained in the delta delay register 205 to the previous value of the accumulator 206 at every rising edge of the local clock, which is driven by the local oscillator 207. The integer change 208 and the fractional value 209 of the accumulator register are passed on to a variable delay block 210. When this addition results in a change to the integer portion of the accumulator register, the variable delay block 210 produces one or more corrected clock edges. The integer change 208 represents the number of corrected clock edges that must be produced by the variable delay block 210. The fractional portion 209 of the accumulator output is used to control the delay (or phase shift) between an edge (rising or falling) of the local clock and the corrected clock edge 211. Methods for implementing a variable delay block will be described later in this document.

The corrected clock edges 211 are used to drive the slave clock counter 212. The value of the slave clock counter 212 will be the actual slave time that will be used by any local elements requiring time knowledge. As the servo loop operates, the slave time will be driven to substantially match the master clock time. The master oscillator 213 and the local oscillator 207 are selected with sufficient stability; and the broadcast rate of the master clock time is sufficient so that the apparatus 200 will operate as a phased locked loop (instead of a frequency locked loop). Thus the apparatus 200 reduces local time error to with +/− of the resolution of the error block 202. Beneficially, the illustrative embodiments provide the ability to measure fractional time errors allows the loop to respond to timing drifts more rapidly than a known system operating under IEEE 1588, which registers no error until the error exceeds one integer value. As such, systems according to the present teachings provide improved accuracy over the IEEE 1588 PTP.

As is known, the transmission of the master clock time value occurs relatively infrequently (e.g., at 2 Hz in the IEEE 1588 standard PTP). This is often called the correction cycle. Accordingly, the determination of the error between the clocks is also measured rather infrequently. Beneficially, the methods, apparatuses and systems of the illustrative embodiments beneficially synchronize the clocks and, barring certain unusual events, maintain at least the synchronization of the integer value of the clocks. As noted, in an embodiment the error can be reduced to (+/−) the resolution of the fractional time error detector. For example if the error block 202 can measure timing errors of +/−10 ns and the master oscillator 213 has a 100 ns period, the method and apparatus of an illustrative embodiment will allow errors of +/−10 ns compared to +/−100 ns for an IEEE 1588 based system. After synchronization has been achieved, the local time is always available and can be used to generate local triggers or to time stamp local events.

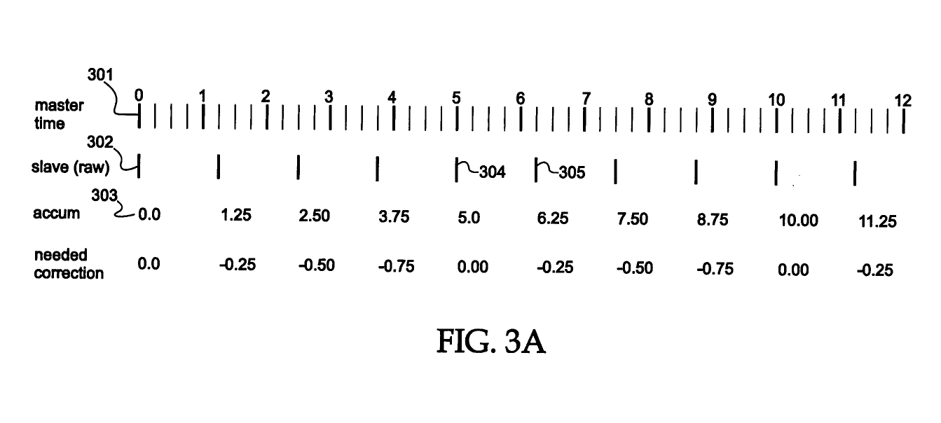

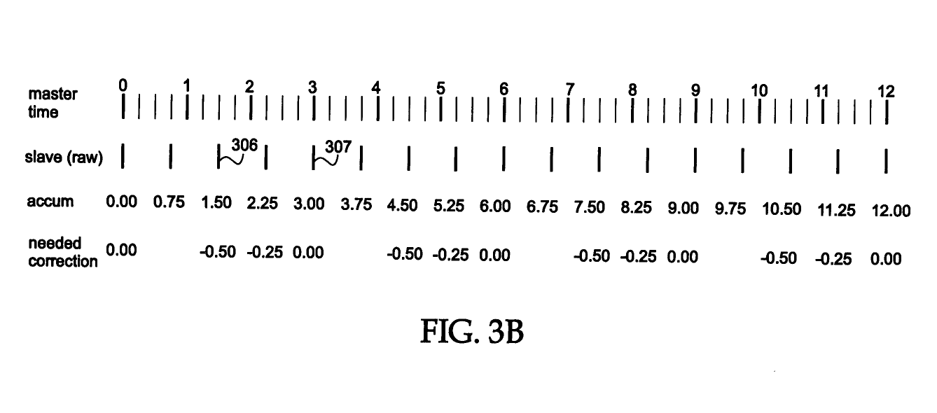

FIG. 3A is a simplified timing diagram showing a master clock time a slave clock time and needed correction for synchronization in accordance with an illustrative embodiment. In the present example, the master clock time 301 and the raw or uncorrected slave clock time 302 are not synchronized. Specifically, the slave clock is running slow compared to the master clock. This example assumes that the servo loop has been operating for sufficient time for the delta delay value to converge.

At each rising clock edge of the slave local oscillator 207, the accumulator value 303 is increased by the amount of the delta delay value determined by the error detector 203 and the servo controller 204. Initially, the accumulator value 303 is zero. At every slave clock edge the accumulator 206 increments with the corresponding delta delay value. If the integer value of the accumulator 206 output increments, an increment signal is produced and the variable delay block produces one or more corrected output clock edges. In this example the delta delay value is 1.25 (time units) indicating that the slave oscillator 207 is running slow compared to the master oscillator 213. This translates into a needed correction of −0.25 units of time for every local clock period, which may be exacted by the variable delay block as described. In the event that the correction was applied, the error would be zero and the process would continue until an error was determined in a subsequent correction cycle, which would then alter the delta delay value 205.

If no correction were exacted, the clocks would continue to drift apart in time, resulting in error in count value, or the integer value of time, and phase, or the fractional value of time. As such, at each clock edge, the accumulator value increases by 1.25 and the needed phase correction increases by −0.25 units of time. Consider clock edge 304. At this point in time, the accumulator registers 5.0 units of time while its previous value was 3.75 units of time. In this case the integer change 208 of the accumulator 206 from the previous slave clock edge is 2 units of time, so the variable delay block 210 must issue a pair of clock pulses to maintain the synchronization of the master and slave clocks. Since the fractional part 209 of the accumulator output is zero, no additional phase shift is needed and the first corrected clock edge will align with the local clock edge and the second will be produced one unit of time after the first.

At clock edge 305, the integer part 208 and the fractional part 209 of the accumulator output are required. The integer part 208 advances the slave clock by providing a clock pulse for each integer increase from the previous accumulator value, and the fractional bit corrects the errors that are less that one clock period by skewing the phase by −0.25 units of time.

From the above example with the local (slave) oscillator 207 running slow with respect to the master oscillator 213, it can be appreciated that the every rising edge from the raw slave clock must produce one or more corrected slave pulses.

FIG. 3B is a timing diagram similar to that of FIG. 3A, except the slave clock is running fast compared to the master clock. As in the previous case, a corrected slave edge is produced when the accumulator integer portion 208 increments. For example, at slave edge 306, the accumulator value is 1.5 time units and the previous value was 0.75 time units. Since the integer portion 208 has changed by one, the variable delay block 210 must generate one corrected edge. Since the fractional portion is 0.5 time units the slave clock can be corrected via the fractional correction of −0.50 time units. This correction is via the fractional delay 209 of the variable delay 210. However, at clock edge 307 the accumulator integer increments from 2.25 time units to 3.00 time units. In this case, one corrected edge must be generated but no phase or fractional time correction is required. As such a corrected slave edge is provided to the slave clock counter 212 without any phase change with respect to the local clock 207 in order to synchronize the count values of the master and slave clocks.

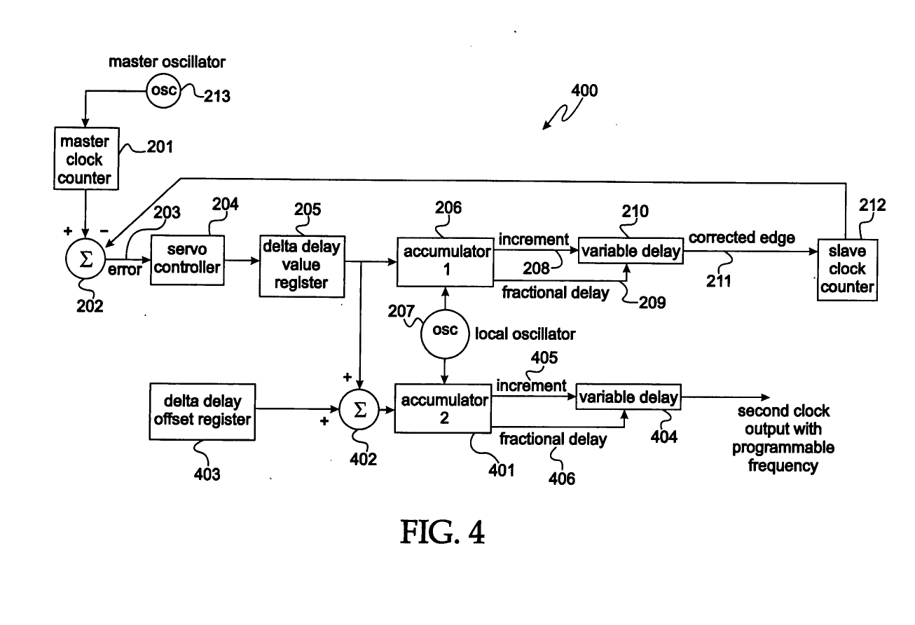

FIG. 4 is a simplified schematic diagram of an apparatus 400 in accordance with another illustrative embodiment. The apparatus 400 includes many common features with the apparatus 200 described previously. Such common features are not repeated to avoid obscuring the description of the present embodiment.

The apparatus 400 includes a second accumulator 401 in order to generate another output clock with programmable frequency. The present value of the delta delay value register 205 is input to a summation block 402. A user programmable delta delay offset value from a programmable delta delay offset register 403 is provided as the second input to the block 402. The block 402 sums the two input values and provides an incremental portion and a fractional portion to create another delta delay value to drive a second variable delay block 404. As can be appreciated, the delta delay value from register 205 is adjusted by the feedback loop operating between the master clock counter 201 and the slave clock counter 212. With feedback operating, the delta delay value corrects the frequency and phase error from the local oscillator 207. The delta delay value represents the time interval between local oscillator clock pulses as measured by the master clock 201. By offsetting the delta delay value and using the second accumulator 401 and a second variable delay block 404, an arbitrary (and programmable) frequency may be generated. This frequency can be higher or lower-than the master clock frequency. Higher frequency outputs require the variable delay clock to be able to produce two or more clock pulses per raw slave clock edge.

The variable delay blocks 210, 404 described previously may be implemented in programmable logic in a variety of ways. Two illustrative embodiments are described presently. It is emphasized that the present teachings contemplate other circuits for this function.

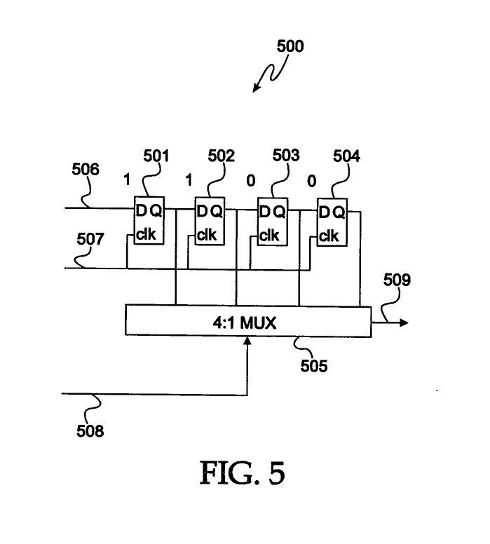

FIG. 5 is a simplified schematic diagram of a variable delay circuit 500 in accordance with an illustrative embodiment. The circuit 500 includes a series of D flip-flops 501-504, which are output to a 4:1 multiplexer (MUX) 505 as shown. At one input 506, the incremental value from the accumulator 206 is provided. At the other input 507 a higher frequency clock is provided which in this example is four (4) times the frequency of the local oscillator 207. The outputs from each of the flip-flops 501-504 is provided to the MUX 505 at each clock edge of the high speed clock input 507. These incremental values are multiplexed with a fractional delay value input 508 that is provided by the accumulator 206. The MUX 505 then outputs a corrected clock edge 509 to increment the slave counter 212. In the embodiment of FIG. 2, the output 509 is the same as the corrected edge 211.

In the present embodiment including four (4) D flip-flops, the clock input 507 has a frequency that is four times that of the slave and master oscillators (e.g., oscillators 207, 213, respectively). This will allow generating a corrected edge with an error of less than one-fourth of a slave clock period. A chain of clocked D flip-flops are used to propagate the local clock oscillators edge, with the edge advancing one flip-flop every edge of the high speed clock input 507. It is emphasized that other clock speeds may be used at the input 507 to further improve the performance.

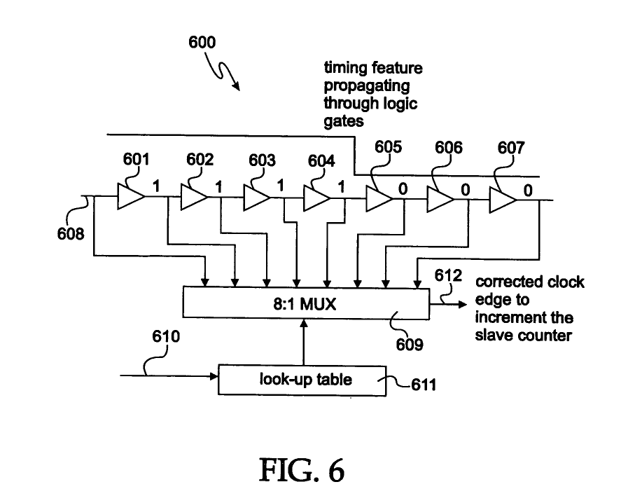

FIG. 6 is a simplified schematic diagram of a variable clock delay circuit 600 in accordance with yet another illustrative embodiment. The present embodiment includes a chain of logic gates 601-607 used to create a delay path for an incoming timing feature 608. Each logic gate 601-607 provides an incremental delay. There must be a sufficient number of logic gates to produce a total delay greater than the local clock period. As in the previous example, the MUX 609 is used to select a point along the delay chain that the pulse gets steered to the output 612, which is the corrected clock edge used to increment the slave counter (e.g., counter 212). As will be appreciated, this provides a variable delay element.

The present embodiment also depicts the use of a look-up table 611, which receives a fractional delay value 610 from the accumulator and allows mapping of fractional time delay values into the appropriate MUX setting. The addition of the look-up table 611 allows the system to be calibrated by measuring the actual delay produced by each logic gate and mapping the best MUX control value for each fractional delay value.

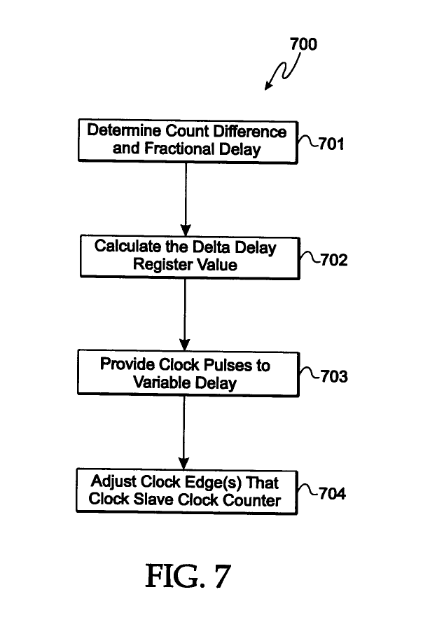

FIG. 7 is a flow-diagram of a method of synchronizing clocks 700 in a network according to an illustrative embodiment. The method is implemented using components described previously in connection with illustrative embodiments. The details of these components and their function are not repeated to avoid obscuring the description of the present embodiment.

At step 701, a count difference and a fractional delay are determined by the error detection block 202 when the local node receives the master time value via a network message. The count difference provides the integer portion and the fractional delay provides the fractional portion of the error 203. At step 702 the integer and fractional portion of the error 203 are used by the servo controller 204 to calculate the delta delay value 205. As described in detail previously, the delta delay value is updated into the register 205 and at each rising edge of the local oscillator 207, the accumulator adds the current register value to the current accumulator value.

At step 703, when the integer portion of the accumulator output 208 changes from its previous value at the rising clock edge of the local oscillator, this indicates that the variable delay block 210 must produce the same number of corrected clock pulses as the value of the change in the integer portion of the accumulator output.

At step 704 the clock edges that will clock the slave clock counter are time adjusted by the fractional delay value 209. In particular, the fractional delay 209 is provided to the variable delay block 210, which in turn issues one or more corrected clock edges with the desired time delay (or phase shift). The fractional portion skews the slave clock edge to be in phase with the master clock edge. The edge alignment can only be achieved down to the level of the resolution of the variable delay block 210.

In accordance with illustrative embodiments, an apparatus for and method of synchronizing clocks are described. The apparatus and method may be used in a network, such as a local area network (LAN). One of ordinary skill in the art appreciates that many variations that are in accordance with the present teachings are possible and remain within the scope of the appended claims. These and other variations would become clear to one of ordinary skill in the art after inspection of the specification, drawings and claims herein. The invention therefore is not to be restricted except within the spirit and scope of the appended claims.

1. An apparatus, comprising:
a master clock counter;
a servo controller;
a slave clock counter;
an error detector block operative to determine a time difference between the slave clock counter and the master clock counter including a relative phase of the master clock counter and the slave clock counter;
an accumulator, which receives a delta delay value from the servo controller based on a present time difference and previous time differences, wherein the accumulator is adapted to output an increment value and a fractional value; and
a variable delay block, which receives the increment value and the fractional value, and is operative to adjust the slave clock counter based on the increment value and the fractional value.

2. An apparatus as recited in claim 1, further comprising a delta delay value register to the accumulator.

3. An apparatus as recited in claim 1, further comprising a local oscillator connected to the accumulator, wherein the accumulator adds the delta delay value to a previous accumulator output value at the rising edge of the local clock.

4. An apparatus as recited in claim 1, wherein the apparatus has a limit cycle substantially equal to a resolution of the error detector.

5. An apparatus as recited in claim 1, wherein the increment value represents a count value difference between the master clock counter and the slave clock counter.

6. An apparatus as recited in claim 1, wherein the fractional value represents a phase difference between a master clock signal and a slave clock signal.

7. An apparatus as recited in claim 1, further comprising: a second accumulator; and a second variable delay block, wherein the apparatus is adapted to output an output clock with a programmable frequency.

8. A network, comprising:
a plurality of nodes, wherein one of the plurality nodes comprises a master clock counter and each of the other nodes comprises a slave clock counter;
a clock synchronization device, which comprises:
an error detector block operative to determine a time difference between the slave clock counter and the master clock counter including a relative phase between the master clock counter and the slave clock counter;
a servo-controller;
an accumulator, which receives a delta delay value from the servo controller based on a present time difference and previous time differences, wherein the accumulator is adapted to output an increment value and a fractional value; and
a variable delay block, which receives the increment value and the fractional value, and is operative to adjust each slave clock counter based on the increment value and the fractional value.

9. A network as recited in claim 8, further comprising at least one measurement device.

10. A network as recited in claim 8, further comprising a delta delay value register.

11. A network as recited in claim 8, further comprising a local oscillator connected to the accumulator, wherein the accumulator adds the error value to a previous error value at each edge of a clock cycle.

12. A network as recited in claim 8, wherein the clock synchronization device has a limit cycle substantially equal to a resolution of the error detector.

13. A network as recited in claim 8, wherein the master clock counter transmits a time to the slave clock counter periodically, and the error detector block determines the time difference between the slave clock counter and the master clock counter based on the time.

14. A network as recited in claim 8, wherein the clock synchronization device further comprises: a second accumulator; and a second variable delay block, wherein the clock synchronization device is adapted to output an output clock with a programmable frequency.

15. A method of synchronizing clocks, the method comprising:
determining a count difference and a fractional delay between a master clock and a slave clock; and
adjusting a clock edge that clocks a slave clock counter by an amount equal to the fractional delay to synchronize the master clock with the slave clock.

16. A method as recited in claim 14, wherein the adjusting further comprises providing at least one pulse to a slave clock to synchronize the master clock with the slave clock.

17. A method as recited in claim 14, wherein the determining further comprises:
measuring a count value of the master clock counter;
measuring a count value of the slave clock counter;
calculating a difference between the count values; and
measuring a phase delay between a master clock signal and a slave clock signal.

18. A method as recited in claim 14, further comprising, after the determining, providing a variable delay to the slave clock, wherein the variable delay comprises an incremental value and the fractional value.
